(19) United States
(12) Patent Application Publication
(10) Pub. No.: US 2023/0261423 A1
(43) Pub. Date: Aug. 17, 2023

(54) SHIELD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroyoshi MAESOBA, Osaka (JP); Toshifumi ICHIO, Osaka (JP)

(21) Appl. No.: 18/024,763

(22) PCT Filed: Jul. 30, 2021
(86) PCT No.: PCT/JP2021/028377

§ 371 Date: Mar. 5, 2023

(30) Foreign Application Priority Data
Sep. 14, 2020 (JP) 2020-153579

(51) Int. Cl. H01R 13/6581; H01R 13/516

(52) U.S. Cl. CPC H01R 13/6581; H01R 13/516

(57) ABSTRACT

The present invention suppresses shield terminal backlash within a housing. This shield connector comprises: a shield terminal (30) of a form in which an inner conductor (31) and a dielectric (33) are surrounded by an outer conductor (34); and a housing (10) in which the shield terminal (30) is accommodated. The housing (10) has a hood portion (17) that surrounds the front end portion of the shield terminal (30) with a space therebetween. The housing (10) has formed therein an elastic contact portion (20) that elastically contacts the outer peripheral surface of the shield terminal (30).

### TECHNICAL FIELD

The present disclosure relates to a shield connector.

### BACKGROUND

Patent Document 1 discloses a shield connector including an electrical connection element formed by integrally assembling an outer conductor, a dielectric and an inner conductor, and a connector housing. The electrical connection element is accommodated in an accommodating portion of the connector housing. A space into which a tubular fitting portion of a mating connector is fit is secured between the outer peripheral surface of a front end part of the electrical connection element and the inner peripheral surface of a receptacle of the connector housing.

### PRIOR ART DOCUMENT

### Patent Document

Patent Document 1: JP H11-339870 A

### SUMMARY OF THE INVENTION

### Problem to be Solved

In an assembled part of the connector housing and the electrical connection element, it is unavoidable that a gap is formed within the range of dimensional tolerances. Thus, there is a concern that the front end part of the electrical connection element rattles in the receptacle and connection to the mating connector is hindered.

A shield connector of the present disclosure was completed on the basis of the above situation and aims to prevent the rattling of a shield terminal in a housing.

### Means to Solve the Problem

The present disclosure is directed to a shield connector with a shield terminal configured such that an inner conductor and a dielectric are surrounded by an outer conductor, and a housing for accommodating the shield terminal, the housing including a receptacle for surrounding a front end part of the shield terminal while being spaced apart therefrom, and the housing being formed with a resilient contact portion for resiliently coming into contact with an outer peripheral surface of the shield terminal.

### Effect of the Invention

According to the present disclosure, it is possible to prevent the rattling of a shield terminal in a housing.

### BRIEF DESCRIPTION OF THE DRAWINGS

FIG. 1 is a perspective view of a shield connector of one embodiment.

FIG. 2 is a perspective view of a housing.

FIG. 3 is a plan view in section of the shield connector.

FIG. 4 is a side view in section of the shield connector.

FIG. 5 is a partial enlarged plan view in section of FIG. 3.

### DETAILED DESCRIPTION TO EXECUTE THE INVENTION

### Description of Embodiments of Present Disclosure

First, embodiments of the present disclosure are listed and described.

(1) The shield connector of the present disclosure is provided with a shield terminal configured such that an inner conductor and a dielectric are surrounded by an outer conductor, and a housing for accommodating the shield terminal, the housing including a receptacle for surrounding a front end part of the shield terminal while being spaced apart therefrom, and the housing being formed with a resilient contact portion for resiliently coming into contact with an outer peripheral surface of the shield terminal. According to the configuration of the present disclosure, since the resilient contact portion of the housing is resiliently held in contact with the outer peripheral surface of the shield terminal, the rattling of the shield terminal in the housing can be suppressed.

(2) Preferably, the housing is formed with a stopper for holding the shield terminal accommodated in the housing in a front stop state, and the outer peripheral surface of the shield terminal is formed with an inclined surface for converting a resilient pressing force from the resilient contact portion into a forward moving force for the shield terminal. According to this configuration, the shield terminal can be held in contact with the stopper by the resilient pressing force of the resilient contact portion.

(3) Preferably, in (2), the shield terminal is formed with a front stop portion for coming into contact with the stopper, and the housing is formed with a groove portion for accommodating the front stop portion only when the shield terminal is inserted in a proper orientation into the housing. According to this configuration, the front stop portion also has an erroneous insertion preventing function of preventing the shield terminal from being inserted in an improper orientation into the housing. Therefore, the shape of the shield terminal can be simplified as compared to the case where a dedicated erroneous insertion preventing portion is formed separately from the front stop portion.

(4) Preferably, the resilient contact portion is in line contact with the outer peripheral surface of the shield terminal. According to this configuration, friction resistance generated between the resilient contact portion and the shield terminal can be reduced in the process of withdrawing the shield terminal from the housing.

(5) Preferably, the resilient contact portion is arranged only in a range of the receptacle behind a back end surface. According to this configuration, the interference of the resilient contact portion with a tubular fitting portion of a mating connector can be prevented when the tubular fitting portion is fit into the receptacle.

(6) Preferably, the housing is formed with a locking lance for retaining the shield terminal while resiliently pressing the outer peripheral surface of the shield terminal, and the resilient contact portion is arranged to press the shield terminal from a direction intersecting a resilient pressing direction by the locking lance. According to this configuration, since the locking lance also has a function of suppressing the rattling of the shield terminal from a direction different from the resilient contact portion, the number of the resilient contact portions can be reduced.

### Details of Embodiment of Present Disclosure

### Embodiment

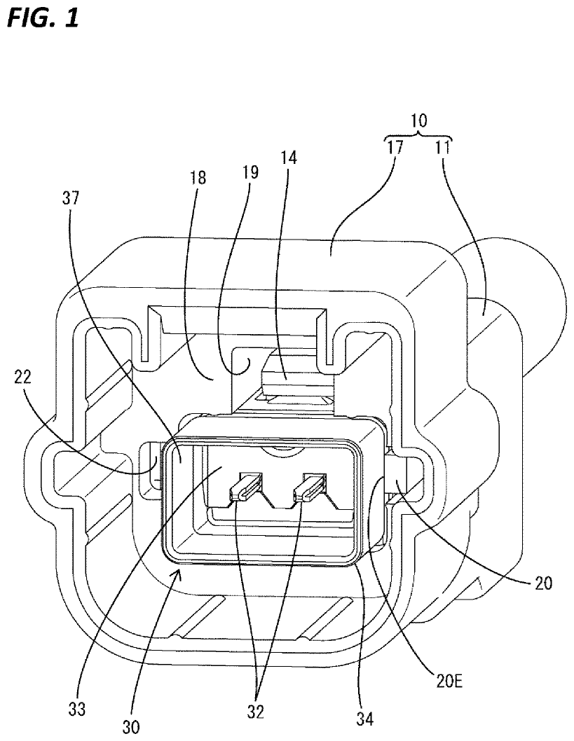

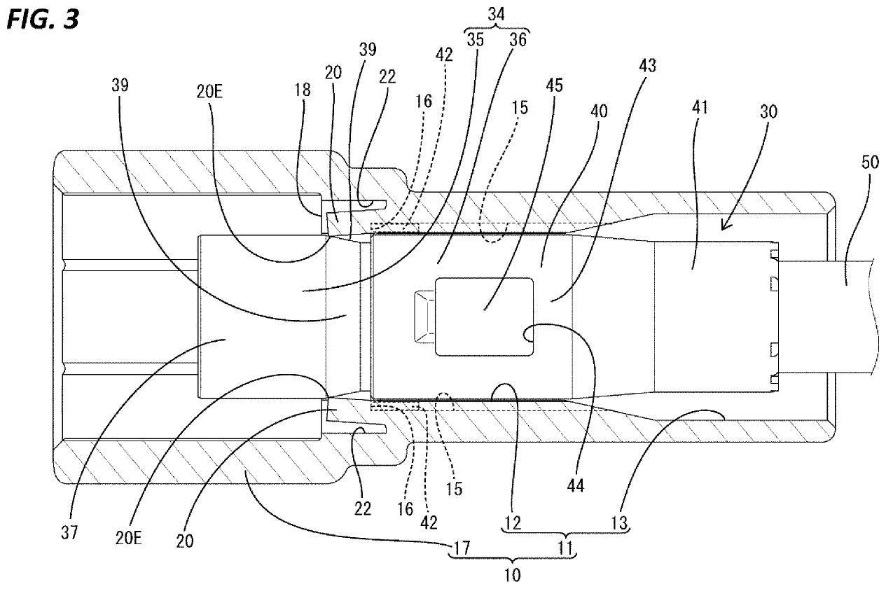

One specific embodiment of a shield connector of the present disclosure is described with reference to FIGS. 1 to 5. Note that the present invention is not limited to these illustrations, but is represented by claims and intended to include all changes in the scope of claims and in the meaning and scope of equivalents. In this embodiment, a left side in FIGS. 3 to 5 is defined as a front side concerning a front-rear direction. Upper and lower sides shown in FIGS. 1, 2 and 4 are directly defined as upper and lower sides concerning a vertical direction. Left and right sides shown in FIG. 3 are directly defined as left and right sides concerning a lateral direction.

The shield connector of the present disclosure is configured by assembling a housing 10 made of synthetic resin and a shield terminal 30. As shown in FIGS. 1 to 4, the housing 10 has a tubular shape hollow in the front-rear direction as a whole. The housing 10 is a single component including a terminal accommodating portion 11 and a receptacle 17 connected to the front end of the terminal accommodating portion 11.

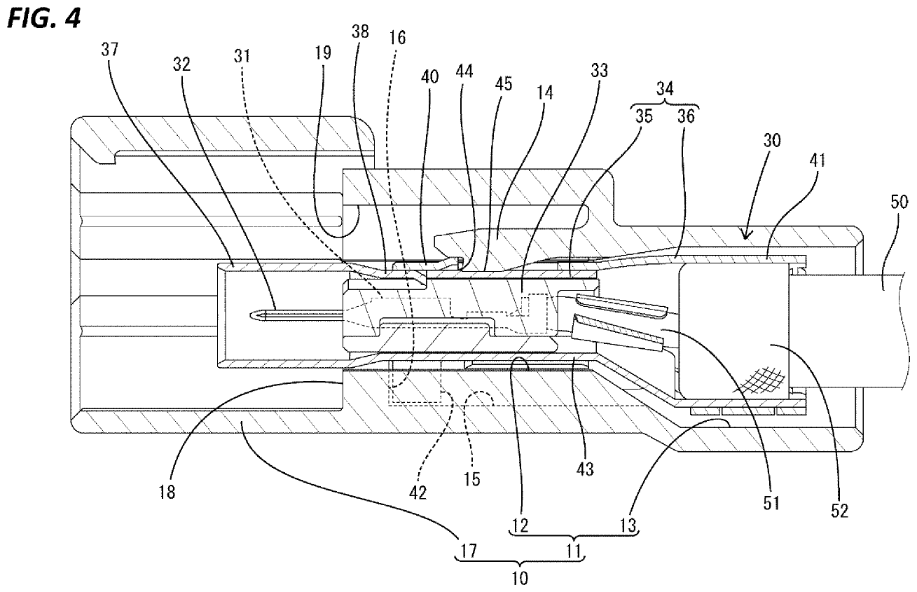

As shown in FIGS. 3 and 4, the terminal accommodating portion 11 includes a first accommodation chamber 12 constituting a front end side part of the terminal accommodating portion 11 and a second accommodation chamber 13 constituting a rear end side part of the terminal accommodating portion 11. As shown in FIG. 4, an upper wall portion constituting the first accommodation chamber 12 is formed with a locking lance 14 resiliently displaceable in the vertical direction. A resilient displacement direction of the locking lance 14 is a direction intersecting a mounting direction of the shield terminal 30 into the housing 10. A height of the second accommodation chamber 13 is larger than that of the first accommodation chamber 12. A width of the second accommodation chamber 13 is larger than that of the first accommodation chamber 12.

A lower wall portion constituting the first accommodation chamber 12 is formed with a pair of left and right groove portions 15. The groove portion 15 extends in the front-rear direction in parallel to an inserting direction of the shield terminal 30 into the terminal accommodating portion 11. A stopper 16 facing rearward is formed in a front end part of the groove portion 15. The rear end of the groove portion 15 is open in the rear surface of the first accommodation chamber 12 and communicates with the inside of the second accommodation chamber 13.

The receptacle 17 is in the form of a rectangular tube cantilevered forward from an outer peripheral part of the front end of the terminal accommodating portion 11. A height of the receptacle 17 is larger than that of the first accommodation chamber 12. A width of the receptacle 17 is larger than that of the first accommodation chamber 12. The receptacle 17 has a back end surface 18. The back end surface 18 is shaped to surround openings at the front ends of the terminal accommodating portion 11 and the first accommodation chamber 12 in a front view of the housing 10. As shown in FIGS. 1, 2 and 4, a mold removal space 19 formed in a step of molding the locking lance 14 and a deflection space for the locking lance 14 is open in the back end surface 18 of the receptacle 17. The mold removal space 19 is open at a position in a laterally central part of an upper edge on the opening edge of the first accommodation chamber 12.

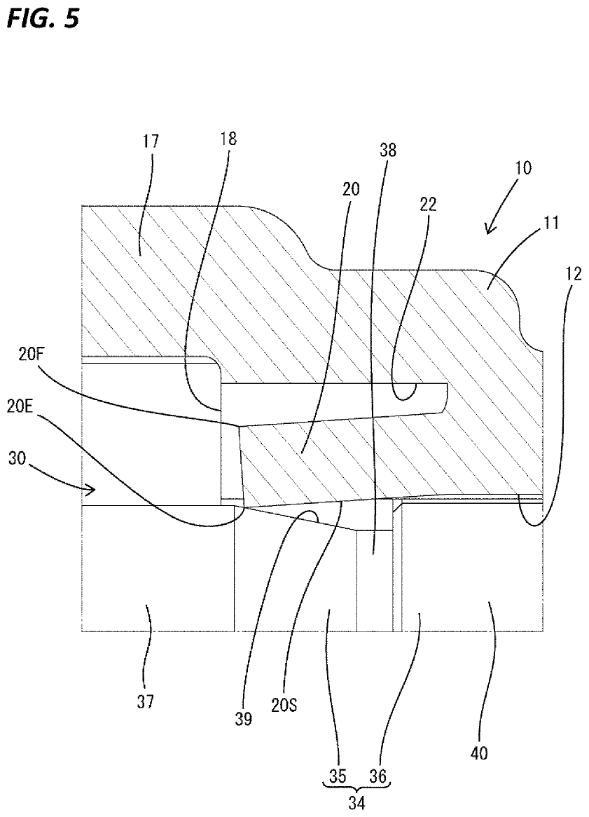

As shown in FIGS. 1 and 3, the housing 10 is formed with a pair of bilaterally symmetrical resilient contact portions 20. The resilient contact portion 20 is a part for resiliently holding the shield terminal 30, and integrally formed to the terminal accommodating portion 11. The resilient contact portion 20 is accommodated in an accommodation recess 22 formed by partially recessing the back end surface 18 of the receptacle 17. The accommodation recess 22 communicates with the inside of the first accommodation chamber 12. The resilient contact portion 20 is cantilevered obliquely forward from the rear end surface of the accommodation recess 22. The pair of left and right resilient contact portions 20 are so inclined that inner surfaces 20S thereof facing each other gradually approach each other toward the front. As shown in FIG. 5, the inner surface 20S of the resilient contact portion 20 is smoothly connected to an inner side surface of the first accommodation chamber 12. A front end 20F of the resilient contact portion 20 is located at a position behind the back end surface 18 of the receptacle 17 in the front-rear direction.

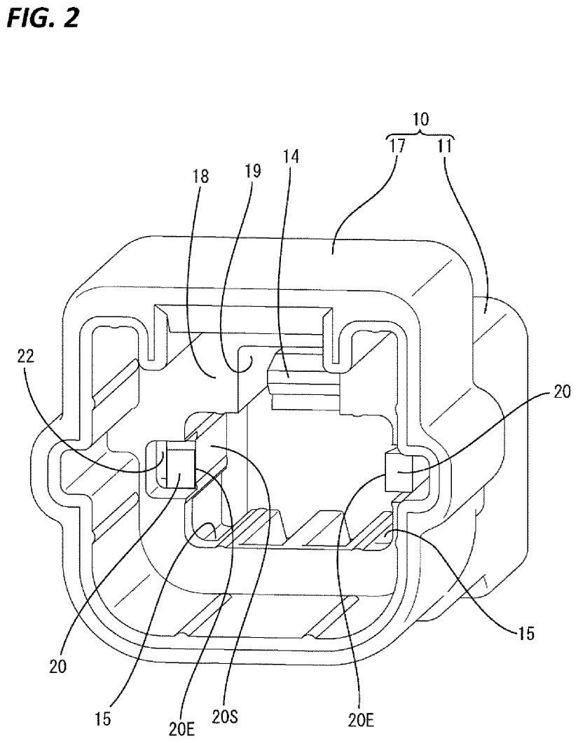

As shown in FIGS. 2, 3 and 5, the front end edges of the inner surfaces 20S of the both left and right resilient contact portions 20 serve as contact edges 20E extending in the vertical direction. A facing distance between the inner surfaces 20S of the both left and right resilient contact portions 20 is minimum between the contact edges 20E. The both left and right resilient contact portions 20 are resiliently displaceable in the lateral direction, which is a direction to separate the inner surfaces 20S from each other. A resilient displacement direction of the resilient contact portion 20 is a direction intersecting the inserting direction of the shield terminal 30 into the terminal accommodating portion 11 and also a direction intersecting the resilient displacement direction of the locking lance 14. As shown in FIG. 5, an interval between the both left and right contact edges 20E is narrower than the width in the lateral direction of the first accommodation chamber 12.

The shield terminal 30 includes a pair of left and right inner conductors 31 made of metal, a dielectric 33 made of synthetic resin and an outer conductor 34. The pair of inner conductors 31 are accommodated in the dielectric 33. The outer conductor 34 surrounds the inner conductors 31 and the dielectric 33. The pair of left and right inner conductors 31 are connected to front end parts of twisted pair wires 51 constituting a shielded cable 50.

The outer conductor 34 is configured by assembling an inner shell 35 made of metal and in the form of a rectangular tube and an outer shell 36 made of metal and surrounding a part of the inner shell 35. The inner shell 35 is a single component including a tubular connecting portion 37 constituting a front end side part of the inner shell 35 and a tubular accommodating portion 38 constituting a rear end side part of the inner shell 35. The dielectric 33 is accommodated in the tubular accommodating portion 38. Tabs 32 at the front ends of the inner conductors 31 project from the front surface of the dielectric 33 and are surrounded by the tubular connecting portion 37.

A height in the vertical direction of the tubular connecting portion 37 is larger than a height of the tubular accommodating portion 38. A width in the lateral direction of the tubular connecting portion 37 is larger than a width of the tubular accommodating portion 38. An inclined surface 39 is formed between the rear end of the tubular connecting portion 37 and the front end of the tubular accommodating portion 38 due to differences between the external dimensions of the tubular connecting portion 37 and those of the tubular accommodating portion 38. The inclined surface 39 is continuous over an entire periphery. The inclined surface 39 is tapered such that a height and a width gradually increase toward the front.

The outer shell 36 has a box shape open in both front and rear end surfaces. The outer shell 36 is a single component including an external fitting portion 40 constituting a front end side part of the outer shell 36 and a crimping portion 41 constituting a rear end side part of the outer shell 36. The external fitting portion 40 is fixed to the tubular accommodating portion 38 of the inner shell 35 while being externally fit to the tubular accommodating portion 38. The external fitting portion 40 includes a pair of front stop portions 42 extending downward from both left and right side plate portions constituting the external fitting portion 40 (see FIGS. 3 and 4). The tubular connecting portion 37 and the inclined surface 39 of the inner shell 35 project further forward than the front end of the outer shell 36 (external fitting portion 40). A width of the external fitting portion 40 and that of the tubular connecting portion 37 are set to be equal. The crimping portion 41 of the outer shell 36 is conductively fixed to a shield layer 52 on the outer peripheral surface of the shielded cable 50.

A front end side region of the shield terminal 30 is constituted by the tubular connecting portion 37 of the inner shell 35. That is, the tubular connecting portion 37 constitutes a front end part of the shield terminal 30 while constituting the front end side part of the inner shell 35 at the same time. A rear end side region of the shield terminal 30 functions as a terminal body portion 43. The terminal body portion 43 is composed of parts of the inner conductors 31 behind the tabs 32, the dielectric 33, the outer shell 36 and the tubular accommodating portion 38. A locking recess 44 is formed in the outer surface of the terminal body portion 43 by partially cutting the external fitting portion 40. A part of the tubular accommodating portion 38 of the inner shell 35 is exposed as a pressure receiving surface 45 in the locking recess 44.

The width of the tubular connecting portion 37 of the shield terminal 30 and that of the terminal body portion 43 are set to be equal. The width of the tubular connecting portion 37 is larger than the facing distance between the both left and right contact edges 20E in a free state where the pair of left and right resilient contact portions 20 are not resiliently deformed.

The shield terminal 30 is mounted into the housing 10 by being inserted into the terminal accommodating portion 11 from behind the housing 10. At this time, if the orientation of the shield terminal 30 with respect to the housing 10 is a vertically inverted improper orientation or an improper orientation turned 90° to the left or right, the front stop portions 42 interfere with the rear end surface of the housing 10. Thus, the shield terminal 30 cannot be inserted into the terminal accommodating portion 11.

If the orientation of the shield terminal 30 with respect to the housing 10 is proper, the front stop portions 42 enter the groove portions 15 without interfering with the rear end surface of the housing 10. Accordingly, the shield terminal 30 is inserted into the housing 10 without any trouble. In the process of inserting the shield terminal 30, the locking lance 14 is resiliently displaced upward by interference with the upper surface of the outer conductor 34. In the process of inserting the shield terminal 30, the outer conductor 34 resiliently slides in contact with the resilient contact portions 20 in passing through the first accommodation chamber 12. In particular, the front end of the tubular connecting portion 37 slides in contact with the inner surfaces 20S of the resilient contact portions 20, and both left and right outer side surfaces of the tubular connecting portion 37 slide in contact with the contact edges 20E. During this time, the resilient contact portions 20 are resiliently displaced in the lateral direction.

If the shield terminal 30 reaches a predetermined insertion position, the front stop portions 42 butt against the stoppers 16, whereby the shield terminal 30 is stopped in front. Simultaneously with this, the resiliently returned locking lance 14 is locked into the locking recess 44, whereby the shield terminal 30 is retained and held in the housing 10. At this time, since the locking lance 14 resiliently presses the pressure receiving surface 45, the shield terminal 30 is pressed against the lower wall portion of the first accommodation chamber 12. By this resilient pressing action of the locking lance 14, the rattling of the shield terminal 30 in the vertical direction with respect to the housing 10 is suppressed.

If the shield terminal 30 reaches the predetermined insertion position, the rear end of the tubular connecting portion 37 passes through the contact edges 20E and the inclined surface 39 is in contact with the contact edges 20E. Since the resilient contact portions 20 are resiliently deformed to expand in the lateral direction even in this state, the contact edges 20E resiliently press the inclined surface 39 by resilient restoring forces of the resilient contact portions 20. Here, the inclined surface 39 is inclined with respect to both the inserting direction of the shield terminal 30 into the housing 10 (front-rear direction) and the resilient displacement direction of the resilient contact portions 20 (lateral direction). Thus, resilient pressing forces in the lateral direction applied to the inclined surface 39 by the resilient contact portions 20 are converted into forward press-in forces for the shield terminal 30. Since the front stop portions 42 are pressed against the stoppers 16 by these forward press-in forces, the rattling of the shield terminal 30 in the vertical direction with respect to the housing 10 is suppressed.

The shield connector of this embodiment is provided with the shield terminal 30 configured such that the inner conductors 31 and the dielectric 33 are surrounded by the outer conductor 34, and the housing 10 for accommodating the shield terminal 30. The housing 10 includes the receptacle 17 for surrounding the front end part of the shield terminal 30 while being spaced apart therefrom. The housing 10 is formed with the resilient contact portions 20 for resiliently coming into contact with the outer peripheral surface of the shield terminal 30. According to this configuration, since the resilient contact portions 20 of the housing 10 are resiliently held in contact with the outer peripheral surface of the shield terminal 30, the occurrence of rattling of the shield terminal 30 in the housing 10 can be suppressed.

The housing 10 is formed with the stoppers 16 for holding the shield terminal 30 accommodated in the housing 10 in front. The outer peripheral surface of the shield terminal 30 is formed with the inclined surface 39 for converting resilient pressing forces from the resilient contact portions 20 into forward moving forces for the shield terminal 30. According to this configuration, the shield terminal 30 can be held in contact with the stoppers 16 by the resilient pressing forces of the resilient contact portions 20.

The shield terminal 30 is formed with the front stop portions 42 to be brought into contact with the stoppers 16. The housing 10 is formed with the groove portions 15 for accommodating the front stop portions 42 only when the shield terminal 30 is inserted in a proper orientation into the housing 10. The front stop portion 42 also has an erroneous insertion preventing function of preventing the shield terminal 30 from being inserted in an improper orientation into the housing 10. Therefore, the shape of the shield terminal 30 can be simplified as compared to the case where a dedicated erroneous insertion preventing portion is formed separately from the front stop portions 42.

The contact edges 20E of the resilient contact portions 20 are not in surface contact, but in line contact with the outer peripheral surface of the shield terminal 30. According to this configuration, in the process of withdrawing the shield terminal 30 from the housing 10, friction resistance generated between the resilient contact portions 20 and the shield terminal 30 can be reduced as compared to the case where the contact edges 20E are in surface contact.

The resilient contact portions 20 are arranged only in a range of the receptacle 17 behind the back end surface 18. According to this configuration, when a tubular fitting portion of a mating connector (not shown) is fit into the receptacle 17, the interference of the resilient contact portions 20 with the tubular fitting portion can be prevented.

The housing 10 is formed with the locking lance 14. The locking lance 14 retains the shield terminal 30 while resiliently pressing the pressure receiving surface 45 on the outer peripheral surface of the shield terminal 30. The resilient contact portions 20 are arranged to press the shield terminal 30 from the lateral direction intersecting a resilient pressing direction by the locking lance 14. Since the locking lance 14 also has a function of suppressing the rattling of the shield terminal 30 from the direction different from the resilient contact portions 20, the number of the resilient contact portions 20 can be reduced.

### Other Embodiments

The present invention is not limited to the above described and illustrated embodiment, but is represented by claims. The present invention is intended to include all changes in the scope of claims and in the meaning and scope of equivalents and also include the following embodiments.

Although two (the pair of) resilient contact portions are provided in the above embodiment, one, three or more resilient contact portions may be provided.

Although the shield terminal is formed with the inclined surface for converting resilient pressing forces from the resilient contact portions into forward moving forces for the shield terminal in the above embodiment, the shield terminal may not have such an inclined surface.

Although the front stop portions also have the erroneous insertion preventing function of preventing the shield terminal from being inserted in an improper orientation into the housing in the above embodiment, a dedicated erroneous insertion preventing portion may be provided separately from the front stop portions.

Although the resilient contact portions come into line contact with the outer peripheral surface of the shield terminal in the above embodiment, the resilient contact portions may come into point or surface contact with the outer peripheral surface of the shield terminal.

Although the resilient contact portions are arranged only in the range of the receptacle behind the back end surface in the above embodiment, the resilient contact portions may be at least partially arranged in front of the back end surface of the receptacle.

Although the locking lance also has the function of suppressing the rattling of the shield terminal in the above embodiment, the locking lance may not have the function of suppressing the rattling of the shield terminal.

### LIST OF REFERENCE NUMERALS

10 . . . housing
11 . . . terminal accommodating portion
12 . . . first accommodation chamber
13 . . . second accommodation chamber
14 . . . locking lance
15 . . . groove portion
16 . . . stopper
17 . . . receptacle
18 . . . back end surface of receptacle
19 . . . mold removal space
20 . . . resilient contact portion
20E . . . contact edge of resilient contact portion
20F . . . front end of resilient contact portion
20S . . . inner surface of resilient contact portion
22 . . . accommodation recess
30 . . . shield terminal
31 . . . inner conductor
32 . . . tab
33 . . . dielectric
34 . . . outer conductor
35 . . . inner shell
36 . . . outer shell
37 . . . tubular connecting portion (front end part of outer conductor)
38 . . . tubular accommodating portion
39 . . . inclined surface
40 . . . external fitting portion
41 . . . crimping portion
42 . . . front stop portion
43 . . . terminal body portion
44 . . . locking recess
45 . . . pressure receiving surface
50 . . . shielded cable
51 . . . twisted pair wire
52 . . . shield layer

1. A shield connector, comprising:
a housing; and
a shield terminal configured such that an inner conductor and a dielectric are surrounded by an outer conductor, the shield terminal being inserted into the housing from behind,
the housing including a receptacle for surrounding a front end part of the shield terminal while being spaced apart therefrom,
the housing being formed with a resilient contact portion for resiliently coming into contact with an outer peripheral surface of the shield terminal in the receptacle,
the housing being formed with a stopper for holding the shield terminal accommodated in the housing in a front stop state,
the outer peripheral surface of the shield terminal being formed with an inclined surface for converting a resilient pressing force from the resilient contact portion into a forward moving force for the shield terminal, and
the shield terminal being held in contact with the stopper by the resilient pressing force of the resilient contact portion.

2. (canceled)

3. The shield connector of claim 1, wherein:
the shield terminal is formed with a front stop portion for coming into contact with the stopper, and
the housing is formed with a groove portion for accommodating the front stop portion only when the shield terminal is inserted in a proper orientation into the housing.

4. A shield connector, comprising:
a shield terminal configured such that an inner conductor and a dielectric are surrounded by an outer conductor; and
a housing for accommodating the shield terminal,
the housing including a receptacle for surrounding a front end part of the shield terminal while being spaced apart therefrom,
the housing being formed with a resilient contact portion for suppressing rattling of the shield terminal by resiliently coming into contact with an outer peripheral surface of the shield terminal in the receptacle,
a contact edge part being formed on a front end edge of the resilient contact portion, and
the contact edge part being in line contact with the outer peripheral surface of the shield terminal.

5. A shield connector, comprising:
a shield terminal configured such that an inner conductor and a dielectric are surrounded by an outer conductor; and
a housing for accommodating the shield terminal,
the housing including a receptacle for surrounding a front end part of the shield terminal while being spaced apart therefrom,
the housing being formed with a resilient contact portion for resiliently coming into contact with an outer peripheral surface of the shield terminal in the receptacle,
the housing being formed with a locking lance for retaining the shield terminal while resiliently pressing the outer peripheral surface of the shield terminal,
the resilient contact portion being arranged to press the shield terminal from a direction intersecting a resilient pressing direction by the locking lance, and
the resilient contact portion and the locking lance suppressing rattling of the shield terminal by coming into contact with the outer peripheral surface of the shield terminal from mutually different directions.

6. The shield connector of claim 1, wherein
the resilient contact portion is arranged only in a range of the receptacle behind a back end surface.

7. The shield connector of claim 4, wherein
the resilient contact portion is arranged only in a range of the receptacle behind a back end surface.

8. The shield connector of claim 5, wherein
the resilient contact portion is arranged only in a range of the receptacle behind a back end surface.
